(19) United States
(12) Patent Application Publication
(10) Pub. No.: US 2015/0302156 A1
(43) Pub. Date: Oct. 22, 2015

(54) SYSTEMS AND METHODS FOR PROCESSING AND DISPLAYING HEALTH AND MEDICAL DATA, PERFORMING WORK TASKS AND DELIVERING SERVICES

(71) Applicant: BABYLON PARTNERS LIMITED, London (GB)

(72) Inventor: Ali Parsadoust, London (GB)

(73) Assignee: BABYLON PARTNERS LIMITED, London (GB)

(21) Appl. No.: 14/682,641

(22) Filed: Apr. 9, 2015

Related U.S. Application Data
(60) Provisional application No. 61/980,411, filed on Apr. 16, 2014.

(51) Int. Cl. G06F 19/00

(52) U.S. Cl. CPC G06F 19/345; G06F 19/328

(57) ABSTRACT

A computer system for processing and displaying medical data is provided. Health data pertaining to a user is received. The received health data is analyzed with respect to a set of active clinical guidelines. Medical diagnosis results are provided to the user based on the analyzed data. The received health data and the medical diagnosis results are displayed to the user via a mobile device. The mobile device is further configured to provide a plurality of health related services.

### CROSS REFERENCE TO RELATED APPLICATIONS

This application claims priority to U.S. patent application Ser. No. 61/980,411 filed Apr. 16, 2014 which is incorporated by reference in its entirety.

### FIELD OF THE INVENTION

This specification is directed, in general, to medical data, and, more particularly, to systems and methods for displaying and managing information, such as health and medical information, and delivering health-related services.

### BACKGROUND OF THE INVENTION

Mobile phones and other digital devices have become increasingly popular in recent years. These devices are used on a daily basis for a variety of different tasks. For instance, mobile devices allow users to check email, send and receive instant messages, check calendar items, take notes, set up reminders, browse the internet, play games or perform any number of different actions using specialized applications or “apps”. These applications allow mobile devices to communicate with other computer systems and perform a wide variety of network-connected tasks previously not possible with a mobile device. As the volume of medical information generated for patient increases, there is an increasing need for handling the medical data and for providing other health-related services in an efficient way using mobile devices.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a computer system for processing and displaying medical data is provided. Health data pertaining to a user is received. The received health data is analyzed with respect to a set of active clinical guidelines. Medical diagnosis results are provided to the user based on the analyzed data. The received health data and the medical diagnosis results are displayed to the user via a mobile device.

In another aspect, the computer system for processing and displaying medical data enables selection of one or more medical tests from a plurality of available tests by a second user. The first is notified of the one or more selected medical tests. The first user is provided an opportunity to pay for the selected tests. In yet another aspect, the computer system is configured to generate a patient referral document to one or more medical specialists for the user based on the analysis of the selected tests' results by the second user.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network for use with the present invention;

FIG. 2 is a schematic diagram illustrating a suitable environment for implementing methods for displaying and managing information, such as medical data, and delivering health-related services according to an embodiment of the present invention;

FIG. 3 is a schematic diagram illustrating a mobile device on which methods for processing and displaying medical data described herein can be implemented;

FIG. 4 is a flowchart of operational steps for ordering medical tests and for reviewing and presenting medical tests' results in accordance with illustrative embodiments of the present invention;

FIG. 5 is a flowchart of operational steps for providing a referral to a clinical specialist in accordance with illustrative embodiments of the present invention;

FIG. 6 is a flowchart of operational steps for analyzing provided medical data in accordance with illustrative embodiments of the present invention;

FIG. 7 is a flowchart of operational steps for providing answers to questions pertaining to users' health in accordance with illustrative embodiments of the present invention;

FIG. 8 is a flowchart of operational steps for automatically submitting a prescription to users' pharmacy of choice in accordance with illustrative embodiments of the present invention;

FIG. 9 is a flowchart of operational steps for receiving and processing users' feedback related to clinical consultations in accordance with illustrative embodiments of the present invention; and

FIG. 10 is a flowchart of operational steps of presenting previously recorded consultation to a user in accordance with illustrative embodiments of the present invention.

### DETAILED DESCRIPTION OF CERTAIN EMBODIMENTS

The present invention is now described more fully with reference to the accompanying drawings, in which illustrated embodiments of the present invention is shown wherein like reference numerals identify like elements. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above.

As used herein, the term “medical data” includes information (e.g., facts) related to diagnosis and treatment of a current or potential health condition (e.g., disease, diabetes, obesity, aging, etc.). In a general sense, medical data refers to any type of numeric, text, voice, video, or script data, or any type of source or object code, or any other suitable information in any appropriate format that may be communicated from one point to another in electronic devices and/or network. In certain embodiments, the term “user” is used herein interchangeably with the term “patient.”

One skilled in the art will appreciate further features and advantages of the invention based on the above-described embodiments. Accordingly, the invention is not to be limited by what has been particularly shown and described, except as indicated by the appended claims. The embodiments herein may generally be performed by a user device (e.g., personal computer, mobile computing device, smartphone, wearable device, etc.) in conjunction with one or more servers (data processing, databases, etc.), and various actions described herein may be related specifically to one or both of the user device and/or the servers. In general, the specific type of user device and/or server configuration may be any suitable configuration (e.g., desktop computers, mobile devices, singular servers, server farms, cloud-based computing, etc.), and any reference to particular type of device herein is not meant to limit the scope of the embodiments herein.

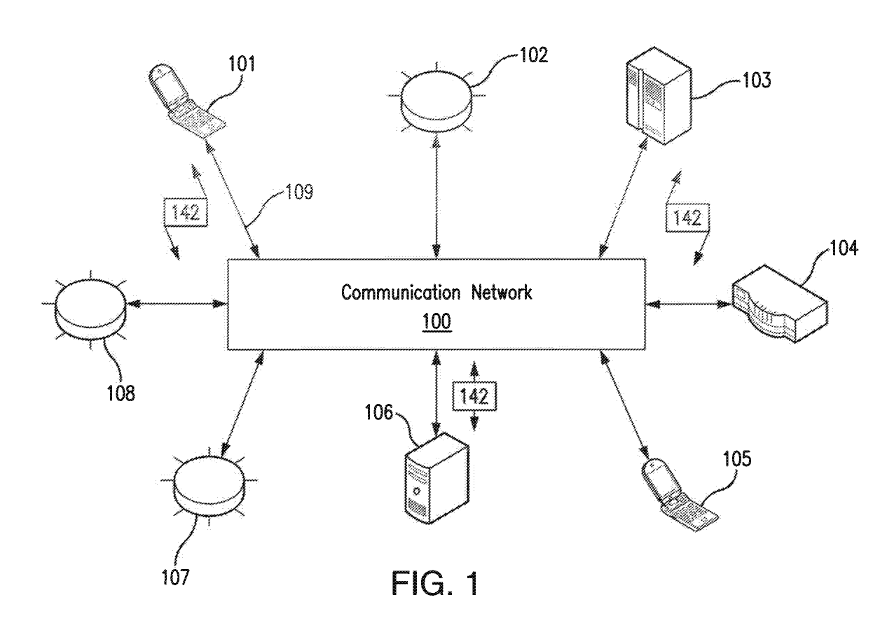

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices, including mobile devices, to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

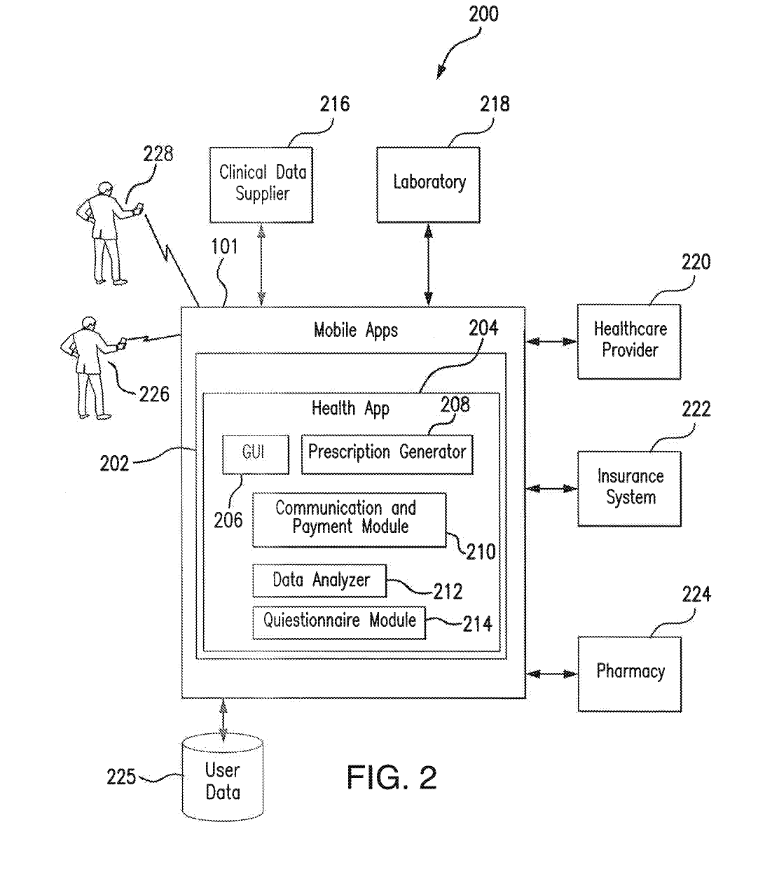

FIG. 2 is a schematic diagram illustrating a suitable environment for implementing methods for displaying and managing information, such as health and medical data, and delivering health-related services via a mobile device according to an embodiment of the present invention. The environment 200 may include components within a mobile device 101 and/or network accessible components 216-225 that communicate with the components within the mobile device via network 100 (shown in FIG. 1). The components within the mobile device 101 may include executable software, software configurations, hardware configurations and controls, and handset operating system interfaces. As disclosed herein, executable software may include, without limitation, any software program stored on the mobile device or associated memory device, both permanently and temporarily connected via hardware or wireless connectivity. The mobile device 101 may include a plurality of applications (“apps”) 202 for performing a plurality of functions and/or for providing a plurality of services.

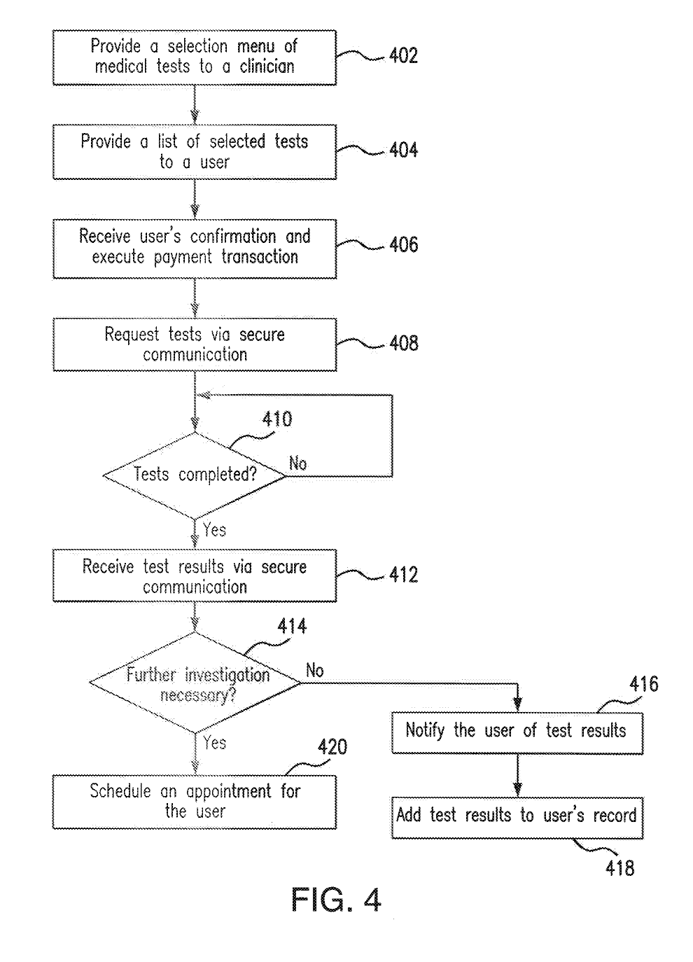

According to an embodiment of the present invention, the plurality of apps 202 installed on the mobile device 101 may include a health app 204 configured and operable to collect, display, process and manage medical and health-related information. The health app 204 is preferably composed of at least one module. More preferably, the health app 204 is preconfigured to include a plurality of modules as shown in FIG. 2. A user customized health app 204 may be described as being defined by a “container application”, may be setup through a user interface that links the different modules and defines the functionality and operation parameters of the modules as shown in FIGS. 4-10. The modules may be developed by any suitable party. For example, the functionality of the health app 204 may utilize one module by a company A which can pass application control to a second module by company B. Additionally, similar to how one app may be configured to use a plurality of modules, a module may itself be configured to use a plurality of other modules.

According to an embodiment of the present invention, the health app 204 may include a graphical user interface (GUI) 206, a prescription generator module 208, a communication and payment module 210, a data analyzer module 212, and a questionnaire module 214. The network accessible components may include a clinical data supplier component 216, a laboratory component 218, a healthcare provider component 220, an insurance system component 222, a pharmacy component 224 and a database of user data 225.

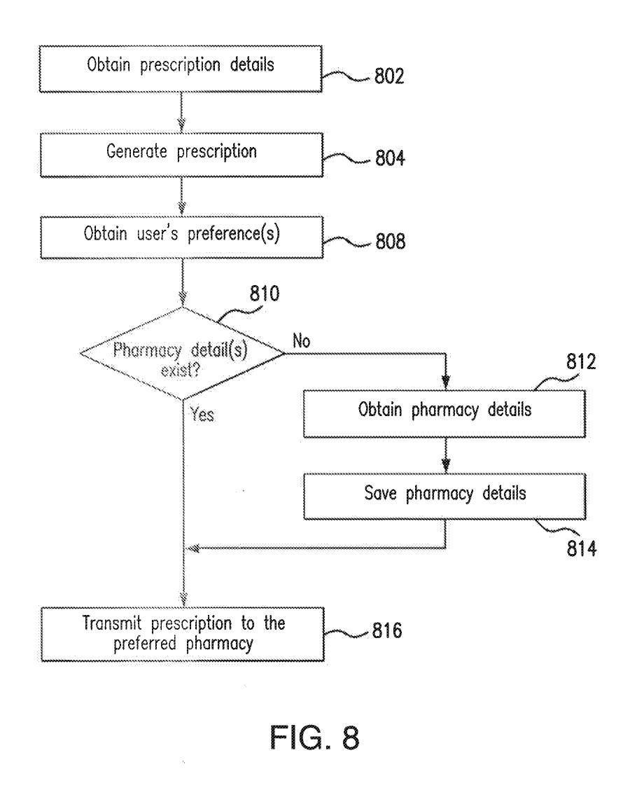

The modules within the health app 204 allow the mobile device 101 to provide and/or implement handset-based services and network-based services. After initial installation and configuration of such a smart device app, the GUI 206 may be provided by means of which a user 226 may be enabled to view various medical and health related data and to issue operational commands to the health app 204. Disclosed herein are user-friendly and convenient GUI methods for facilitating user input and for transferring medical data between the mobile device 101 and the network accessible components 216-225. The prescription generator 208 may be configured to generate determined medical prescriptions and to submit the generated prescription to users' pharmacy of choice, as discussed below with reference to FIG. 8. The communication and payment module 210 may comprise an input/output module operatively connected to various clinical data sources including, but not limited to, clinical data supplier 216 and laboratory 218, various service providers including, but not limited to, healthcare provider terminals (such as doctor/clinician/nurse terminals). In addition, the communication and payment module 210 may be configured to store and retrieve information in/from the database of user data 225. In one embodiment, the database of user data 225 comprises a cloud-based storage system. The data analyzer module 212 is preferably configured to analyze health data pertaining to the user 226 with respect to a set of active clinical guidelines. The data analyzer module 212 is further configured to provide medical diagnosis and/or one or more recommendations based on the analyzed data. The questionnaire module 214 is configured to create a structured questionnaire that enables the user to provide additional health related information. In one embodiment, the structured questionnaire generated by the questionnaire module 214 is presented to a user via GUI 206. The structured questionnaire captures medical and health related data using very specific questions, each having a corresponding input field. The input fields are populated by users and the data thus captured facilitates quick insights to the health problem defined by the user.

The network accessible components 216-225 enable the mobile device 101 to communicate with and to retrieve data from outside the device, such as from the clinical data supplier 216. The network accessible components 216-225 may include wired and wireless components. One or more medical data suppliers 216 preferably comprise one or more real-time databases, such as a Clinical Data Repository (CDR) or Clinical Data Warehouse (CDW), that consolidate data from a variety of clinical sources to present a unified view of a single patient. Furthermore, some of the clinical data suppliers 216 may comprise currently available electronic devices that track a user's energy expenditure throughout the day by way of monitoring physiological parameters such as heart rate and/or blood pressure. Such devices include the BodyMedia Fit/GoWear Fit (BodyMedia, Inc., Pittsburgh, Pa.), Body Bugg (24 Hour Fitness, Carlsbad, Calif.), FitBit (Fitbit, Inc., San Francisco, Calif.), DirectLife (Philips Electronics North America, Andover, Mass.), Zeo (Zeo Inc., Newton, Mass.), and Polar FA 20 (Polar Electro Inc., Lake Success, N.Y.). Such devices provide a report of energy expenditure following daily activities and also routine and strenuous physical activities in units of energy expenditure per minute.

In addition, the communication and payment module 210 of the health app 204 may be configured to obtain test results from one or more laboratories 218, such as a hospital lab. In some embodiments the laboratory component 218 may include laboratory analyzers or other laboratory instruments configured to obtain test results. Examples of laboratory analyzers used to analyze patient samples include flow cytometers, hematology analyzers, immunoassay analyzers, and electrophoresis analyzers. It will also be recognized that numerous other laboratory analyzers may be used to analyze patient samples. Furthermore, the laboratory component 218 may store electronic data corresponding to test results performed by manual testing.

Furthermore, the health app 204 may be configured to interact with a plurality of healthcare provider components 220, pharmacy components 224 and insurance systems 222. In one embodiment, the provider component 220 may be an interface viewable by the provider as the provider interacts with the patient during the patient encounter. Typically, the patient encounter is an interactive session wherein the provider is examining the patient in a clinic setting or in the examining room of an office or other healthcare facility and eliciting information from the patient by questioning the patient. The environment of use however is not meant to be limiting and may also include an encounter in a real-time multimedia session setting described below. It is to be appreciated that the expression “provider” may denote a physician. However, the provider may, in fact, be almost any healthcare worker who is interacting with the patient during the patient encounter. Thus, a provider could easily be a nurse or a nurse practitioner, a physician's assistant, a paramedic, or any other healthcare worker involved in the delivery of treatment and care to the patient during the patient encounter. It is contemplated that each of these healthcare workers may have access to the healthcare provider components 220. As described below, the health app 204 may also exchange data with various insurance systems 222. For example, insurance providers may need to be consulted to approve payment transactions. As described below in conjunction with FIG. 8, the health app 204 may be configured to submit generated prescriptions to devices or computer systems operated by local pharmacies 224. The pharmacy 224 may be a retail pharmacy, a mail order pharmacy, a specialty pharmacy, or the like, or an entity that is at least partially responsible for filling prescription drug orders.

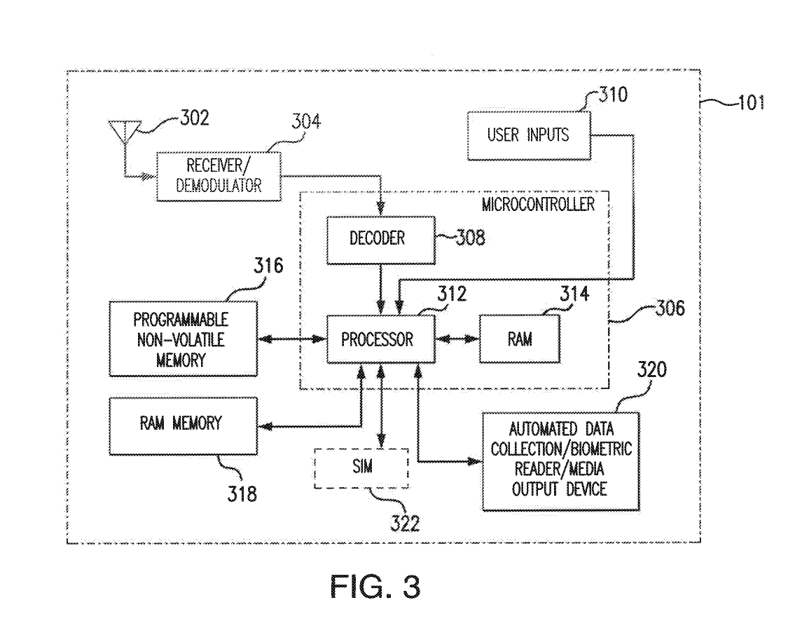

FIG. 3 is a schematic diagram illustrating mobile device 101 on which methods for processing and displaying medical data described herein can be implemented. A receiver/demodulator 304 receives a transmitted signal via an antenna 302 and reconstructs the original transmitted signal. The transmitted signal is sent to a microcontroller 306, which consists of a decoder 308, a processor 312, and RAM (Random Access Memory) 314. The decoder 308 translates the signals into meaningful data and interfaces to other devices. Decoded data, along with subscriber inputs 310, are sent to the processor 312. In addition, the mobile device may include optional components, such as an automated data collection 320 unit linked to the processor 312, which can include an automated RFID (Radio Frequency Identification) tag reader, a magnetic card swipe reader, a bar code reader, and others. Additionally, or alternatively, the mobile device 101 may include a biometric reader (e.g., thumbprint reader, voice fingerprint recognition functionality, etc.), and/or a media output device (e.g., MP3 player, television tuner/player, etc.) 320. The mobile device 101 may also include a subscriber identity module (SIM) 322. The output of the processor 312 can be stored in a programmable non-volatile memory 316 or in the RAM memory 318. The mobile device 101 may also include user output components, such as a display screen, speakers, and other components that enable a user to interact with the mobile device. The user 226 (shown in FIG. 2) may interact via input components, such as a keypad, via the screen (using touch-based interfaces), via voiced inputs, and so on.

Additionally, the subscriber identity module, or SIM card 322, may contain any or all of the processing components, memory components or storage components described herein. To that end, the device may perform SIM card 322 based processing, memory, or storage.

FIG. 3 and the discussion herein provide a brief, general description of a suitable telecommunications or computing environment in which the technology can be implemented. Although not required, aspects of the technology are described in the general context of computer-executable instructions, such as routines executed by a general-purpose computer, e.g., a server computer or personal computer. Those skilled in the relevant art will appreciate that the technology can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, and the like. Indeed, the terms “computer,” “host,” and “host computer,” and “mobile device” and “handset” are generally used interchangeably herein, and refer to any of the above devices and systems, as well as any data processor.

Aspects of the technology can be embodied in a special purpose computing device or data processor that is specifically programmed, configured, or constructed to perform one or more of the computer-executable instructions explained in detail herein. Aspects of the technology may also be practiced in distributed computing environments where tasks or modules are performed by remote processing devices, which are linked through a communications network, such as a LAN, WAN, or the Internet. In a distributed computing environment, program modules may be located in both local and remote memory storage devices.

Aspects of the technology may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the technology may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the technology reside on a server computer, while corresponding portions reside on a client computer such as a mobile or portable device, and thus, while certain hardware platforms are described herein, aspects of the technology are equally applicable to nodes on a network.

With the exemplary communication network 100 (FIG. 1) and computing device 101 (FIGS. 2 and 3) being generally shown and discussed above, description of certain illustrated embodiments of the present invention will now be provided. With reference now to FIGS. 4-10, depicted are certain illustrated embodiments of the present invention.

Various embodiments contemplate an integrated system 200 for displaying and analyzing medical data. Such system preferably includes the mobile device 101 connected to a cloud based storage system 225. According to an embodiment of the present invention, the system 200 is configured and operable to perform a suitable analysis of medical data and diagnostic test results with respect to a set of active clinical guidelines. In another aspect, the mobile device 101 is configured to provide various health related services. As described below, such services may be provided by an app and may include, without limitation, an ability to order, pay for and review results of diagnostic medical tests. In another aspect, the mobile device 101 is configured to generate referral documents and/or medical prescriptions, which may be automatically sent to user's pharmacy of choice. The mobile device 101 further enables users 226 to communicate with clinicians 228 and/or other healthcare providers by either asking questions and/or by booking and undertaking a corresponding real-time video consultation. At the conclusion of the consultation, the above described system 200 preferably collects user's feedback. This feedback may be archived along with other consultation related information in the cloud based storage 225. In addition, the users 226 are enabled to selectively replay previously recorded and archived consultation sessions.

In various embodiments, the computer system for processing and displaying medical data 200 comprises an application, such as health app 204, installed on the mobile device 101. In one embodiment, GUI 206 of the health app 204 is preferably configured to present to a user 226 a dashboard for the integrated display of data from clinical investigation, other clinical data and fitness and wellness data for patient health in a mobile environment. The health app 204 may be further configured to provide the reactive and proactive diagnosis of health and wellbeing conditions through concurrent analysis of multiple user metrics. It is to be appreciated, an illustrated embodiment of the present invention includes a dashboard for the integrated display of medical test results data—such as urine test results, radiology results and blood test results—that are obtained via clinical investigation. Furthermore, the dashboard may be configured to present other clinical data—such as blood pressure and user heart rate and fitness and wellness data such as data relating to sleep, stress, and exercise. In addition, the displayed data may include user's medical history, genetic data, nutrition data, and the like. It is noted, data from clinical investigation, other clinical data, genetic data, nutrition data and fitness and wellness data are preferably collated within a single dashboard and presented to the user 226.

FIGS. 4-10 are flowcharts of operational steps of the health app 204 of FIG. 2 in accordance with various illustrative embodiments of the present invention. Before turning to description of FIGS. 4-10, it is noted that the flow diagram shown therein is described, by way of example, with reference to components shown in FIGS. 1-3, although these operational steps may be carried out in any system and are not limited to the scenario shown in the aforementioned figures. Additionally, the flow diagrams in FIGS. 4-10 show examples in which operational steps are carried out in a particular order, as indicated by the lines connecting the blocks, but the various steps shown in these diagrams can be performed in any order, or in any combination or sub-combination. It should be appreciated that in some embodiments some of the steps described below may be combined into a single step or omitted altogether. In some embodiments, one or more additional steps may be included.

With reference now to FIG. 4, FIG. 4 is a flowchart of operational steps for ordering medical tests and for reviewing and presenting medical tests' results in accordance with illustrative embodiments of the present invention. A clinician 228 (including, without limitation, a general practitioner or nurse) may identify the need for a user 226 of the health app 204 to undertake a clinical (medical) test—for example, a blood test. Preferably, the clinicians 228 have the health app 204 downloaded and installed on their respective mobile devices 101. At 402, the GUI 206 of the health app 204 presents a menu from which the clinician 228 selects an appropriate medical test type(s) for the user 226 to undertake. In one embodiment, in response to receiving clinician's selection, the health app 204 running on the clinician's device sends the selection to user's mobile device 101 either directly or via a remote server, which may be cloud-based server, for example. At 404, the GUI 206 of the second instance of the health app 204 running on the user's device 101 preferably presents the list to the user 226. Advantageously, from within the GUI 206 environment of the health app 204, the user 226 may preferably confirm their intention to order the tests at step 406. In various embodiments, the health app 204 may enable the user 226 to choose a particular fulfilment option. For example, if a particular test is capable of being sent to the user 226 by mail and the sample safely collected by the user 226, the user 226 may elect for the test to be sent to them by mail, collect the sample themselves, and return the sample, by mail, for processing. Alternatively, the user 226 may elect to attend a drop-in medical center to have the test undertaken. As yet another option, where applicable, the user 226 may elect to request the call-out of a clinician to administer the test at the user's specified address. In some embodiments, in addition to confirming their intentions to order specified tests, at step 406, users 226 may pay for the tests and/or submit a claim to their insurance company to pay for the tests. For example, the communication and payment module 210 of the health app 204 may implement a payment transaction via establishing a connection with the insurance system 222 operated by user's insurance company to submit a corresponding claim.

At step 408, the health app 204 preferably transmits the test order to the relevant external pathology provider, such as the laboratory component 218, according to the fulfilment method selected by the user, via secure electronic communication link. The secure communication link may operate using a secure sockets layer (SSL) protocol, encryption protocol or other secure system protocol which allows access by authorized parties only.

Next, at step 410, after the test has been completed, the health app 204 may periodically communicate with the lab component 218 to check whether the sample has been analyzed by the external pathology provider. In one embodiment, this step may be performed by the health app 204 installed on the device of a clinician who recommended the tests. In response to determining that the sample has been analyzed and results are ready (decision block 410, “yes” branch), the results are passed from the lab component 218 of the external pathology provider to clinician's health app 204 via a secure communication link. The clinician 228 then reviews the results via health app's 204 GUI interface. At step 414, the health app 204 prompts the clinician 228 to indicate whether any further investigation or consultation is required. If no further investigation or consultation is necessary (decision block 414, “no” branch), at step 416, a notification alert is sent to the patient's health app 204 indicating that the results do not require further investigation or consultation. Step 416 may further involve sending the test results to patient's mobile device 101 for the patient to view via a dashboard presented by the GUI 206 of health app 204. It is to be further understood the dashboard also preferably performs, and displays the results of, analysis of data values relative to clinically recognized guidelines and recognized scales. In various embodiments, the use of ‘traffic-light’ (green, amber and red) and other visual display methodologies may be used to highlight to users values that are within or outside recommended ranges. Optionally, at step 418, the received test results may be added to the patient's record maintained by the clinical data supplier 216 and/or to the cloud based database 225. If the clinician 228 indicates that further investigation or consultation is required (decision block 414, “yes” branch), at step 420, a notification alert is sent to user's health app 204 requesting to make an appointment with the clinician who recommended the test and/or reviewed the test results. Step 420, may further involve the health app 204 booking an appointment with the clinician or another healthcare provider (i.e., another clinical/medical specialist) via, for example, the healthcare provider's component 220. At least in some cases, booking an appointment with the medical specialist may require a referral document.

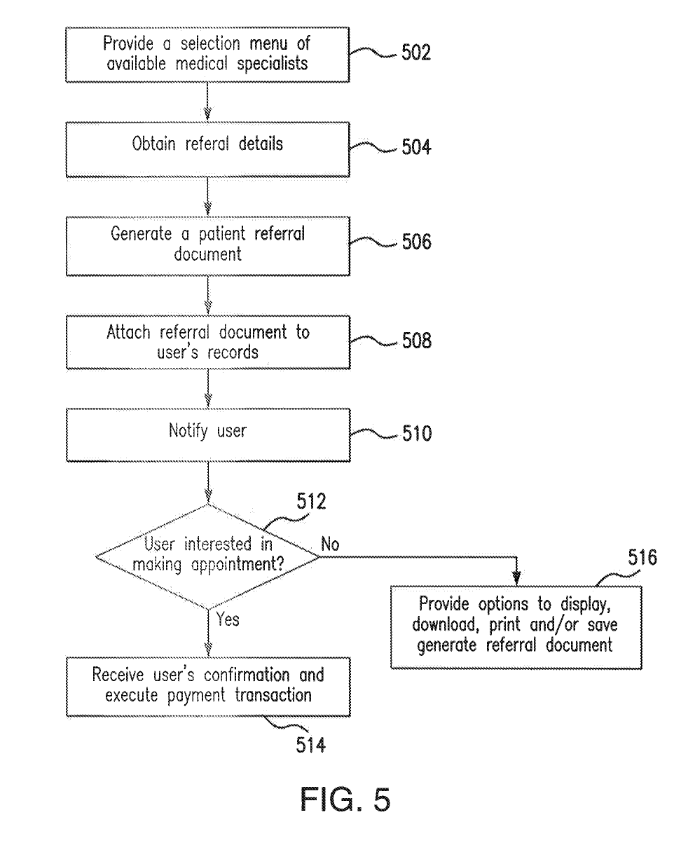

With reference now to FIG. 5, operational steps for providing a referral to a clinical specialist or another healthcare provider are briefly described in accordance with illustrative embodiments of the present invention. In one embodiment, the clinician 228 (including, without limitation, a general practitioner or nurse) preferably identifies the need for the user 226 of the health app 204 to undertake a consultation with a medical specialist. Accordingly, at 502, the GUI 206 of the health app 204 installed on clinician's device preferably presents a menu from which the clinician 228 selects an appropriate specialty (for example, cardiology) for the user's referral. At step 504, the health app 204 may prompt the clinician 228 to complete the details required to generate a referral, such as the patient's name, address, prescribing clinician's name, address, medical license number, and the like. Any medical condition thresholds necessary to justify the prescribed treatment may also be included in the referral details.

According to an embodiment of the present invention, at step 506, the health app 204 generates a patient referral document. Optionally, at step 508, the referral document may be added to the patient's record stored in the database 225, for example. Next, at step 510, a notification alert is sent to user's health app 204 indicating that a referral letter is available and the user 226 may then access the referral document within GUI 206 of the health app 204. At step 512, the health app 204 may prompt users to indicate whether they are interested in consultation with the recommended clinical specialist. If interested (decision block 512, yes block), the user 226 may then elect to book and pay for (where applicable) a consultation with the recommended clinical specialist at step 514. For example, the communication and payment module 210 of the health app 204 may implement a payment transaction via establishing a connection with the insurance system 222 operated by user's insurance company to submit a corresponding claim. In some embodiments, users 226 may then be able to undertake the consultation from within the health app 204 via a live conference with an available medical specialist.

Alternatively, the user 226 may elect to book, pay for (where applicable) and undertake an appointment with a clinical specialist who is not accessible via the health app 204 (decision block 512, “no” branch). In this case, at step 516, the health app 204 may provide users options to display, download, print and share (electronically and otherwise) the referral letter they have received.

Additionally, the health app 204 may also be configured to perform automated triage of symptoms, proactive analysis and diagnosis of potential health and wellbeing conditions. Based on the analysis, the health app 204 may offer a recommendation to seek medical advice from a practitioner.

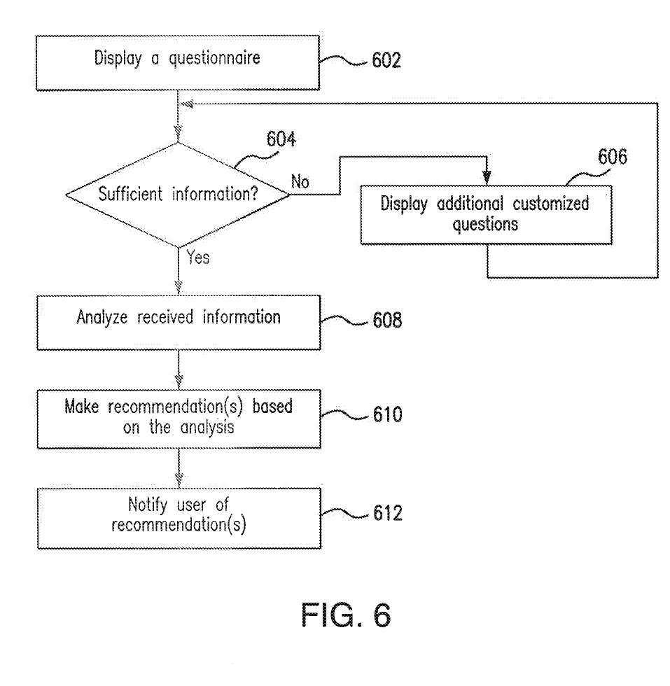

FIG. 6 is a flowchart of operational steps for analyzing provided medical data in order to provide a recommendation in accordance with illustrative embodiments of the present invention. At step 602, the questionnaire module 214 of the health app 204 preferably asks the user 226 screening questions in accordance with conventional patient diagnosis schemes. For example, the medical analysis questionnaire includes questions based on a set of predefined processing rules described below. In one embodiment, the questionnaire module 214 may present a discrete set of questions about the patient's perceived health status to the patient 226 via GUI 206. For example, without limitation, the user 226 is prompted to specify the relevant body part (including, without limitation, whether the area of concern is within a joint or between joints). The questionnaire module 214 may then ask the user 226 some additional questions, such as, without limitation, whether the concern is the result of trauma and whether the area of concern is weight-bearing, whether the concern is progressing, whether the concern causes pain, whether the concern has swelling or tenderness, and the like. For example, for each part of the body the user 226 may be required to select options from pre-populated drop-down menus, wheels or yes/no buttons. Alternatively, the patient 226 may also be presented with the queries and any background information in a less graphical format, such as in a conventional questionnaire.

At step 604, the questionnaire module 214 determines whether sufficient information for making a recommendation has been provided. For example, the questionnaire module 214 may determine whether the user 226 provided answers to all questions, whether it is necessary to ask questions about additional body parts, etc. In response to determining that additional information is needed (decision block 604, “no” branch), at step 606, the questionnaire module 214 presents additional customized questions to the user 226. If the provided information is sufficient (decision block 604, “yes” branch), at 608, the data analyzer module 212 of the health app 204 analyzes the provided information correlated with medical test results, patient's medical history and/or other clinical data displayed by the dashboard as discussed above in conjunction with FIG. 4. In one embodiment, the data analyzer module 212 may analyze provided data according to a set of predefined processing rules. The processing rules may include specific rules such as acceptable ranges and/or error tolerance levels for each type of medical data. Such permutations, tolerance levels and ranges can be based upon recognized medical understanding and guidelines, in the context of which the user's own historic, and present, clinical and nonclinical data may be assessed. For instance, an increase in blood glucose to particular levels or by a certain amount, combined with an increase in blood creatinine to certain levels or by a certain amount, may be indicative of poorly controlled diabetes. As another example, a decrease in the user's hemoglobin to certain levels or by a certain amount, combined with an increased frequency of poor sleep to certain levels or by a certain amount, combined with weight loss to certain levels or by a certain amount, may be suggestive of a cancer. In alternative embodiment, the data analyzer module 212 may utilize a database of possible permutations of inputs to determine the likely urgency of the user's complaint. As described above, for each part of the body the user 226 is required to select options from pre-populated drop-down menus, wheels or yes/no buttons. In this embodiment, the data analyzer module 212 may then compare the correlated data to a database of possible permutations in order to determine the urgency of the user's complaint and make the appropriate recommendations.

At step 610, the health app 204 provides a recommendation based on the analysis performed by the data analyzer module 212 at step 608. In one exemplary embodiment, the health app 204 preferably recommends one of five possible outcomes: (1) no clinical action is required; (2) at their convenience, the user should undertake a consultation with a clinician; (3) that day, the user should undertake a consultation with a clinician; (iv) the user should seek urgent assessment or use of the emergency services; (v) the user should visit a dentist. At step 612, GUI 206 of the health app 204 may display recommendations to the user 226. In some embodiments, results of the analysis performed at step 608 and/or provided recommendations, with the user's permission, may be uploaded to the user's record stored in the cloud-based database 225.

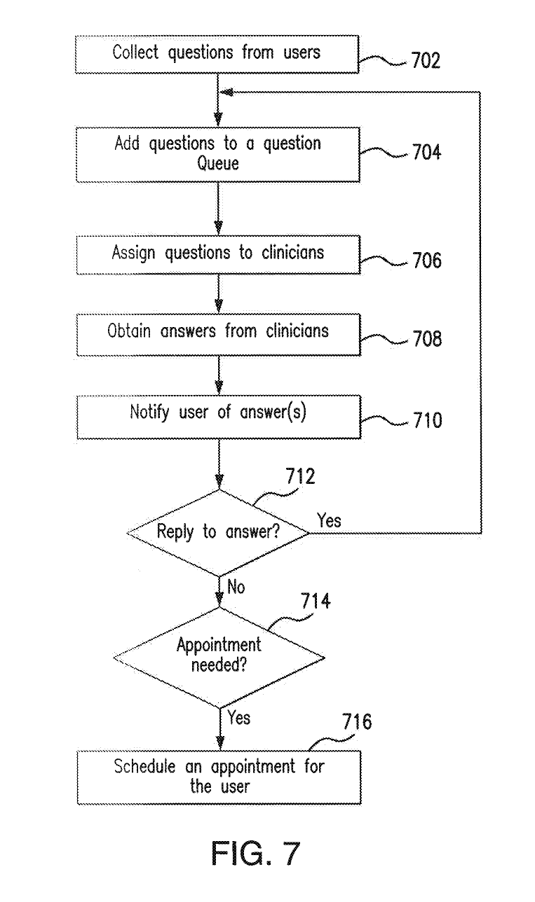

FIG. 7 is a flowchart of operational steps for providing answers to questions pertaining to users' health in accordance with illustrative embodiments of the present invention. In one embodiment, at 702, the user 226 may submit typed questions via GUI 206 of the health app 204. Also, in certain aspects, the communication module 210 of the health app 204 may allow the user 226 to upload photos/video and/or additional files, such as, without limitation, voice files and PDF files, that are related to user's questions. In one embodiment of the present invention, questions from users join a cloud-based question queue that is accessible to a plurality of clinicians. Accordingly, at step 704, the health app 204 places the submitted questions into such queue.

At step 706, health app 204 may assign questions to one or more clinicians selected from the plurality of clinicians based on their area of expertise, for example. In an alternative embodiment, clinicians 228 may access the health app 204 to assign to themselves questions they wish to answer. In response to a question, depending upon the question's content, the clinician 228 can provide a written answer and/or recommends that a clinical consultation be undertaken. At step 708, the health app 204 determines whether the assigned clinicians have provided a written answer. If the clinician 228 provided a written answer, at step 710, the health app 204 notifies the user 226, for example, by displaying a corresponding message and/or the written answer via GUI 206. In some cases, after reviewing clinician's answer the user 226 may then reply to the clinician 228 with a follow-up question. Accordingly, at step 712, the health app 204 determines whether any follow-up questions have been submitted. In response to determining that additional questions have been submitted (decision block 712, “yes” branch), the health app 204 preferably repeats steps 704-710 until all submitted questions are answered. At step 714, the health app 204 determines whether any of the clinician's answers recommended that a clinical consultation be undertaken. In response to determining that one or more clinical consultations may be required, at 716, the health app 204 provides the user 226 an option to book an appointment with the clinician or another healthcare provider (i.e., another clinical/medical specialist) via, for example, the healthcare provider component 220, if they wish. At least in some cases, booking an appointment with the medical specialist may require a referral document, as described above. In some embodiments, users 226 may then be able to undertake the consultation from within the health app 204 via a live conference.

FIG. 8 is a flowchart of operational steps for automatically submitting a prescription to users' pharmacy of choice in accordance with illustrative embodiments of the present invention. As previously indicated, the clinician 228 may preferably identify the need to issue, to the user 226, a prescription for medication. In one embodiment, the prescription generator 208 of the health app 204 may be configured to generate such medical prescriptions.

At step 802, the prescription generator 208 captures medical prescription information using GUI 206, for example. Next, at step 804, the prescription generator 208 generates a prescription for one or more medications in electronic form based on the information acquired and provides a corresponding notification to the user 226 that a prescription has been made available.

According to an embodiment of the present invention, at step 808, the prescription generator 208 obtains users' preferences with respect to fulfilling the prescription. For example, users may elect to receive the prescription personally, in which case the prescription is sent to an address they nominate via regular mail. Alternatively, users 226 may instruct the prescription generator 208 to fulfill the prescription, in which case the prescription may be sent by the prescription generator 208 to a third party prescription system which will select and dispatch by regular mail the specified medication to the user's address.

In yet another embodiment, the user 226 may instruct the prescription generator 208 to have the prescription sent to a pharmacy in the vicinity of the location associated with the user 226. If the user 226 elects to have the prescription sent to a pharmacy in the vicinity of their current location, the location associated with the user 226 is accessed or obtained by the prescription generator 208. The location as accessed may be, for example, of the mobile device 101, where the user 226 is located or perceived to be located. The location may also be a typical location for the user 226, e.g., home, business, club, workout facility, or the like, in which case, the prescription generator 208 enables the user 226 to manually input their preferred location. The location may be identified in terms of street address, latitude and longitude coordinates, another type of geographic location identifier, or otherwise. Furthermore, based on at least the location associated with the user 226, the prescription generator 208 generates and/or receives a pharmacy list. In general, the pharmacy list identifies a number of pharmacies that are in the vicinity of the user 226. The pharmacies may be listed by name, address, and phone number. However, the pharmacies may otherwise be listed with more or less information. In one embodiment, based on at least the location associated with the user 226, the prescription generator 208 generates and/or receives a map (e.g., through third party application programming interfaces (APIs)). In general, the map is a graphical representation of a geographic area that identifies a number of pharmacies that are in the vicinity of the user 226. The pharmacies may be indicated on the map by identifiers. In accordance with an embodiment of the present invention, the prescription generator 208 enables the user 226 to select a preferred pharmacy from those displayed (e.g., via mobile device's 101 touch screen).

At step 810, the prescription generator 208 determines if selected pharmacy's relevant information (e.g., contact information) is available based on stored historical information, for example. In response to determining that such relevant information associated with the preferred (selected) pharmacy is available (decision block 810, “yes” branch), the prescription generator 208, at step 816, transmits the generated prescription to the preferred pharmacy, for example, by communicating with the pharmacy component 224. In addition, the prescription generator 208 informs the user 226 that the prescription is available for fulfilment. The user 226 may visit the pharmacy and collect their medication. In response to determining that relevant pharmacy information is not available (decision block 810, “no” branch), at step 812, the prescription generator 208 attempts to obtain such relevant details by exchanging information with the pharmacy component 224. At step 814, the prescription generator 208 saves the retrieved pharmacy information for future reference. Next, the prescription generator 208 preferably performs step 816 as described above.

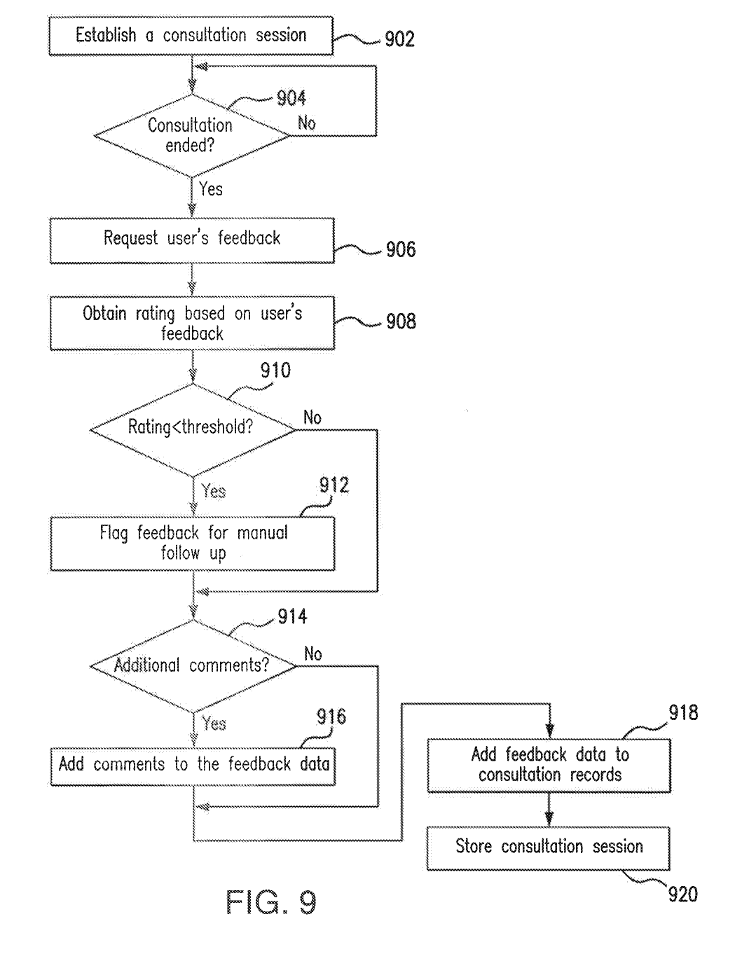

FIG. 9 is a flowchart of operational steps for rating and monitoring users' feedback related to clinical consultations in accordance with illustrative embodiments of the present invention. As previously indicated, the health app 204 is configured to enable the user 226 to book and undertake a live video consultation with a clinician using their mobile device 101. At step 902, the health app 204 establishes a synchronous multimedia consultation session between the client 226 and the clinician 228. In one embodiment, the health app 204 sends an invitation, such as a consultation session invitation, to both the user 226 and the clinician 228. At step 904, the health app 204 preferably periodically checks the status of the consultation session established in step 902 to determine whether the consultation has ended. In response to determining that the synchronous consultation between the user 226 and the clinician 228 has completed (decision block 904, “yes” branch), at step 906 the health app 204 displays a notification requesting the user 226 to provide both qualitative feedback and a quantitative rating. If the user 226 elects not to leave feedback, the consultation is complete.

According to an embodiment of the present invention, if the user 226 elects to leave feedback, at step 908, the health app 204 solicits user's quantitative feedback using, for example, a zero to five star rating system. Next, at step 910, the health app 204 determines whether the submitted rating is below a pre-configured threshold criterion. In one embodiment, the pre-configured rating threshold criterion may be expressed as “greater than or equal to 3 stars”. In response to determining that the user 226 submitted the rating value lower than the threshold value (decision block 910, “yes branch), at step 912, the submitted feedback is preferably flagged so that any appropriate follow-up action can be taken by a service manager or other responsible person or team of a service group associated with the health app 204. In response to determining that the star rating submitted by the user 226 meets or exceeds the threshold value (decision block 910, “no” branch) or subsequently to performing step 912, at 914, the health app 204 prompts the user 226 to provide qualitative feedback. In one embodiment, the user 226 may provide qualitative feedback by entering textual evaluation comments. If the user 226 elects to leave one or more textual comments (decision block 914, “yes” branch), the health app 204 adds these textual comments to a comprehensive feedback data record at step 916. In response to determining that the user 226 is not interested in providing any textual evaluation comments (decision block 914, “no” branch) or subsequently to performing step 916, the health app 204 preferably adds the feedback data to a record associated with the completed consultation session at step 918. At step 920, the health app 204 stores all the session data along with user's feedback and clinician's notes and/or prescriptions (if any). In one embodiment, session records may be stored and archived in the cloud based database 225 so that they can be searched and retrieved in the future.

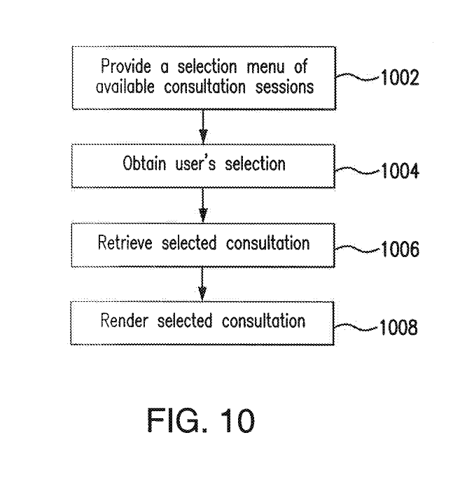

FIG. 10 is a flowchart of operational steps of presenting previously recorded consultation to a user in accordance with illustrative embodiments of the present invention. At step 1002, the health app 204 provides a selection menu of archived consultation sessions to the user 226. The user can then select one or more sessions for immediate playback and the health app 204 obtains user's selection at step 1004. Next, at step 1006, the health app 204 retrieves information associated with the selected consultation session from the cloud based user data database 225. At step 1008, the health app 204 plays the selected consultation recording on the user's mobile device 101.

In summary, various embodiments contemplate an integrated system for displaying and analyzing medical data. Such system preferably includes a mobile device coupled with a cloud based storage system. According to an embodiment of the present invention, the system is configured and operable to perform a suitable analysis of medical data and diagnostic test results with respect to a set of active clinical guidelines. In another aspect, the mobile device is configured to provide various health related services. As described above, such services may include, without limitation, an ability to order, pay for and review results of diagnostic medical tests. In another aspect, the mobile device is configured to generate referral documents and/or medical prescriptions, which may be automatically sent to user's preferred pharmacy. The mobile device app further enables users to communicate with clinicians and/or other healthcare providers by either asking questions and/or by booking and undertaking a corresponding real-time video consultation. At the conclusion of the consultation, the above described system preferably collects user's feedback. This feedback may be archived along with other consultation related information in the cloud based storage. In addition, users are enabled to replay previously recorded and archived consultations sessions.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. An integrated computer system for processing and displaying medical data, the computer system comprising one or more processors, one or more computer-readable storage devices, and a plurality of program instructions stored on at least one of the one or more storage devices for execution by at least one of the one or more processors, the plurality of program instructions comprising:
program instructions to receive health data pertaining to a first user;
program instructions to analyze the health data with respect to a set of active clinical guidelines; and
program instructions to provide medical diagnosis results to the first user based on the analyzed data.

2. The integrated computer system of claim 1, wherein the health data comprises at least one of: medical history, clinical data, genetic data, medical test results, nutrition data, fitness data and wellness data.

3. The integrated computer system of claim 1, wherein the program instructions to receive the health data pertaining to the first user further comprise program instructions to receive the health data pertaining to the first user from a third-party health data supplier.

4. The integrated computer system of claim 1, further comprising program instructions to display the received health data and the medical diagnosis results to the first user on a mobile device.

5. The integrated computer system of claim 1, wherein the program instructions to analyze the health data with respect to a set of active clinical guidelines comprise program instructions to analyze the health data using a plurality of predefined processing rules.

6. The integrated computer system of claim 2, wherein the health data comprises medical test results and wherein the plurality of program instructions further comprise:
program instructions to enable selection of one or more medical tests from a plurality of available medical tests by a second user;
program instructions to notify the first user of the one or more selected medical tests; and
program instructions to enable payment for the one or more selected tests by the first user.

7. The integrated computer system of claim 6, wherein the program instructions to enable payment further comprise program instructions to submit claim information related to the one or more selected medical tests to an insurance company.

8. The integrated computer system of claim 7, wherein the program instructions to receive health data comprise program instructions to receive results of the one or more selected medical tests via a secure link and wherein the program instructions to provide the medical diagnosis results comprise program instructions to provide the received results to the second user prior to providing the received results to the first user.

9. The integrated computer system of claim 8, further comprising program instructions to generate a patient referral document to one or more medical specialists for the first user responsive to the second user reviewing the received results and program instructions to notify the first user of the generated referral document.

10. The integrated computer system of claim 9, further comprising program instructions to book an appointment with the one or more medical specialists and program instructions to enable payment for the booked appointment by the first user.

11. The integrated computer system of claim 5, wherein the program instructions to analyze the health data further comprise program instructions to present a medical analysis questionnaire for input by the first user, wherein the medical analysis questionnaire includes questions based on the plurality of predefined processing rules, and program instructions to receive responses of the first user to the medical analysis questionnaire.

12. The integrated computer system of claim 11, further comprising program instructions to process the received responses and program instructions to provide a recommendation regarding urgency of needed medical care to the first user.

13. The integrated computer system of claim 6, wherein the program instructions to receive the health data pertaining to the first user comprise program instructions to enable the first user to submit a question pertaining to first user's health, wherein the question includes at least one of a visual image, a video file or an audio file.

14. The integrated computer system of claim 13, wherein the program instructions to receive the health data pertaining to the first user comprise program instructions to enable the second user to answer the question submitted by the first user and program instructions to provide the answer to the first user.

15. The integrated computer system of claim 1, further comprising program instructions to generate one or more prescriptions based on the provided medical diagnosis results.

16. The integrated computer system of claim 15, further comprising program instructions to submit the one or more prescriptions to at least one of a lab, a pharmacy and a prescription system.

17. The integrated computer system of claim 6, further comprising program instructions to provide a live multimedia session between the first user and the second user, wherein the second user provides a multimedia consultation to the first user.

18. The integrated computer system of claim 17, further comprising program instructions to receive first user's feedback regarding the multimedia consultation.

19. The integrated computer system of claim 17, further comprising program instructions to store the multimedia consultation and program instructions to retrieve and render the retrieved multimedia consultation to the first user at a later time.

20. A computer program product for processing and displaying medical data, the computer program product comprising:
one or more computer-readable storage devices and a plurality of program instructions stored on at least one of the one or more computer-readable storage devices, the plurality of program instructions comprising:
program instructions to receive health data pertaining to a first user;
program instructions to analyze the health data with respect to a set of active clinical guidelines; and
program instructions to provide medical diagnosis results to the first user based on the analyzed data.
